(19) United States
(12) Patent Application Publication
(10) Pub. No.: US 2008/0246974 A1
(43) Pub. Date: Oct. 9, 2008

(54) Portable Optical Measurement Assembly

(76) Inventors: Jean Laurent Wilson, Kirkland (CA); Thomas Edward Lucas, Clifton Park, NY (US); Jacques Lamond, Vaudreuil-Dorion (CA)

Correspondence Address: WOLF, BLOCK, SHORR AND SOLIS-COHEN LLP, 250 PARK AVENUE, 10TH FLOOR, NEW YORK, NY, 10177, US

(21) Appl. No.: 12/058,522

(22) Filed: Mar. 28, 2008

Related U.S. Application Data
(60) Provisional application No. 60/908,519, filed on Mar. 28, 2007.

(51) Int. Cl. G01B 11/02; G01C 5/00; G01B 11/24

(52) U.S. Cl. 356/634; 33/290; 702/167

(57) ABSTRACT

A portable optical measurement assembly for measuring the dimensions of an upper peripheral region of a wall structure of a swimming pool is provided. The assembly comprises an optical unit subassembly including an optical unit casing. The optical unit casing encloses a light source structured and arranged to direct a light beam onto an upper peripheral region of the wall structure of a swimming pool and a sensor structured and arranged to provide data indicative of the distance from the light source to the particular point on the upper peripheral region of a wall structure of a swimming pool surface. The portable optical measurement assembly also includes a mounting assembly for rotationally supporting the optical unit subassembly.

### CROSS REFERENCE TO RELATED APPLICATION

Applicants claim priority of U.S. Provisional Patent Application No. 60/908,519, filed Mar. 28, 2007, entitled “System and Apparatus for Automated Spatial Dimensions Measurements.” The entire disclosure of U.S. Provisional Patent Application No. 60/908,519 is incorporated herein by reference.

### FIELD OF INVENTION

The present invention relates generally to a portable optical measurement assembly and methods and more specifically to an apparatus and method for measuring the dimensions of a swimming pool such as to facilitate the manufacture of a custom fit pool liner and a custom fit safety cover.

### BACKGROUND OF THE INVENTION

Conventional in-ground swimming pools are outfitted with liners made from polyvinyl-chloride (PVC) which are fitted to the shape of the swimming pool, generally formed by plastic wall panels. These liners provide a waterproof barrier preventing water from seeping out of the pool into the surrounding ground. Over time, such liners are prone to develop tears due to exposure to chlorine and other chemicals in the water, sunlight as well as regular wear and tear caused by normal use. The liners need be replaced periodically and a new liner must be fit to the shape of the pool.

It is not uncommon to provide a cover over a swimming pool, such as during the winter when the pool is not used in order to prevent debris from falling into the pool and for safety purposes. These covers must be custom-fit to accommodate the shape of the perimeter of the pool as well as structures substantially in close proximity to the perimeter of the pool, such as plant beds and diving boards.

Since swimming pools are built with variations in shape and size, in order to achieve a good fit, a pool liner and pool cover must be custom manufactured to the specific dimensions of a pool. The process of taking measurements for manufacture of a replacement liner or pool cover can be tedious and expensive. Traditionally, contractors have had to measure the length, width and depth of the pool at numerous points along the pool with a measuring tape in order to acquire the necessary measurements. The contractor must record each of the measurements manually and subsequently enter each of the measurements into a computer program which generates a three-dimensional model of the pool's shape. From that three-dimensional model, liner portions can be cut and manufactured. Small errors in measurement can lead to incorrectly fitted pool liners which can be aesthetically unpleasing and are expensive to replace.

Generally, in order to measure a swimming pool for manufacture of a swimming pool cover or swimming pool liner, at least two individuals must be on site. A first individual places a measuring tape at a first point along the perimeter of the pool and measures the distance to various points around the perimeter of the swimming pool from that spot. A second individual places a measuring tape at a second point along the perimeter and takes measurements that correspond to the same points that the first individual made around the perimeter of the swimming pool. The data points must be entered into a computer before measurement data can be generated, which can be time-consuming.

Some systems are known for use in facilitating the manufacture of swimming pool liners. For example, see U.S. Pat. No. 7,280,433. However, such systems generally must be immersed in the water for use. Additionally, such systems cannot be used for facilitating the manufacture of safety covers.

### SUMMARY OF THE INVENTION

Accordingly, it is an object of the present invention to provide a new and improved portable optical measurement assembly and methods for obtaining dimensional measurements.

It is still another object of the present invention to provide a portable optical measurement assembly particularly suited for measuring the dimensions of a swimming pool.

It is yet another object of the present invention to provide an apparatus and method for measuring the dimensions of a swimming pool for the manufacture and fitting of a swimming pool liner.

Still another object of the present invention is to provide an apparatus and method for measuring the dimensions of a swimming pool for the manufacture and fitting of a swimming pool cover.

Another object of the present invention is to provide a method of taking measurements for the manufacture of a swimming pool cover and swimming pool liner that minimizes inaccuracies that are caused by human error.

These and other objects of the present invention are attained by providing a portable optical measurement assembly for measuring the dimensions of an upper peripheral region of a wall structure of a swimming pool. The assembly comprises an optical unit subassembly including an optical unit casing. The optical unit casing encloses a light source structured and arranged to direct a light beam onto an upper peripheral region of the wall structure of a swimming pool and the light source and a sensor structured and arranged to provide data indicative of the distance from the light source to the particular point on the upper peripheral region of a wall structure of a swimming pool surface. The portable optical measurement assembly also includes a mounting assembly for rotationally supporting the optical unit subassembly.

Advantageously, the mounting assembly includes a housing in which the other components of the assembly can be stored for portability.

A method of measuring the dimensions of a swimming pool is provided comprising the steps of providing a portable optical measurement assembly comprising an optical unit casing including a light source structured and arranged to direct a light beam onto an upper peripheral region of a wall structure of a swimming pool surface, positioning the portable optical measurement assembly at a perimeter edge of a swimming pool such that the optical unit casing is at a first position level with the upper peripheral region of the wall structure of a swimming pool surface, rotating the light source and directing the light beam onto points around substantially the entire upper peripheral region of the wall structure of swimming pool surface, measuring the distance from the light source to the upper peripheral region of the wall structure of the swimming pool surface, and collecting and storing measurement data points indicative of the dimensions of the swimming pool.

In addition to the method described above, measurement data indicative to the depth of the pool is taken. The measurement data points indicative of the dimensions of the swimming pool and measurement data indicative of the depth of the pool is transmitted to a processor. The processor generates a three-dimensional depiction of the swimming pool which is used for the manufacture of a swimming pool liner.

A portable optical measurement system for measuring the dimensions of an upper peripheral region of a wall structure of a swimming pool is also provided. In addition to the portable optical measurement assembly described above, the system also includes markers for indicating a change in depth of a swimming pool and a data storage device structured and arranged to receive and store measurement data points obtained by portable optical measurement assembly.

### BRIEF DESCRIPTION OF THE FIGURES

A more complete appreciation of the present invention and many of the attendant advantages thereof will be readily understood by reference to the following detailed description of preferred embodiments of the invention when taken in conjunction with the accompanying drawings, in which:

FIG. 1 is a top view of a portable optical measurement assembly in accordance with the embodiment of the invention;

FIG. 2 is a side view of the portable optical measurement assembly as shown to FIG. 1;

FIG. 3 is a perspective view of the portable optical measurement assembly as shown to FIG. 1;

FIG. 4 is a cross-sectional view of the optical unit casing, wherein the light source is in a first position;

FIG. 5 is a cross-sectional view of the optical unit casing as shown in FIG. 4, wherein the light source is rotated to a second position;

FIG. 6 is a perspective view of an elongate rack disengaged from the portable optical measurement assembly as shown in FIG. 2;

FIG. 7 is a top view illustrating the portable optical measurement assembly as shown in FIG. 1 deployed at a swimming pool and markers placed at the shallow end break and the deep end break;

FIG. 8 is a perspective view of a portable optical measurement assembly as shown in FIG. 7;

FIG. 9 is a perspective view of the marker as shown in FIG. 7; and

FIG. 10 is perspective view of a portable optical assembly used to collect measurement data points for structures surrounding the perimeter of a swimming pool.

### DETAILED DESCRIPTION OF THE INVENTION

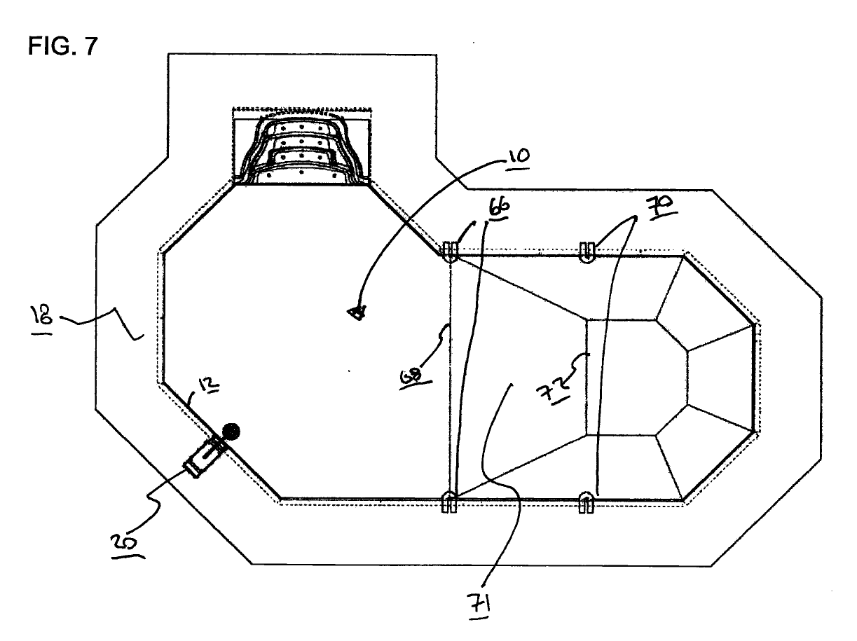

Referring now to the drawings, in which like reference characters designate identical or corresponding parts throughout the several views and more particularly FIG. 7, a portable optical measurement assembly for measuring the dimensions of an in-ground swimming pool for the manufacture of a swimming pool liner or swimming pool cover is designated 20.

As will be more fully described below, the portable optical measurement assembly 20 is situated proximate to a perimeter edge 12 of a swimming pool 10. Portable optical assembly 20 directs a light beam at multiple points along substantially the entire upper peripheral region of the surface of a wall structure of swimming pool 10. Measurement data indicative of the dimensions of the swimming pool are processed and used to generate a depiction of the swimming pool which facilitates manufacture of a swimming pool liner or swimming pool cover.

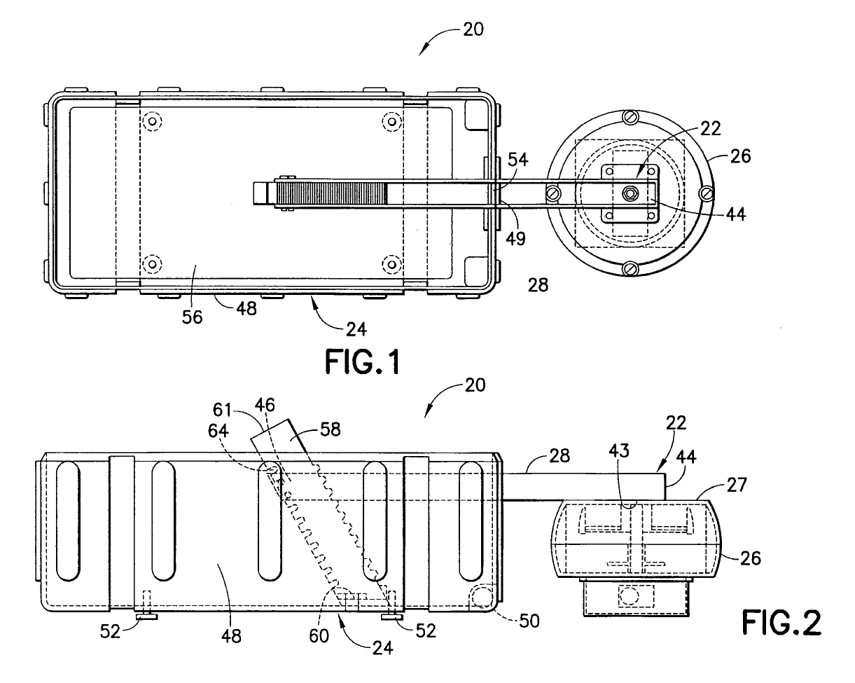

Referring to FIGS. 1, 2 and 3, portable optical measurement assembly 20 comprises an optical unit subassembly 22 and a mounting assembly 24. Optical unit subassembly 22 includes an optical unit casing 26, having an upper surface 27 connected to a lower surface 43 of first end 44 of an elongate support beam 28 which connects optical unit casing 22 to mounting assembly 24. Elongate support beam 28 is preferably formed of a metallic substance such as steel, although other materials may be employed.

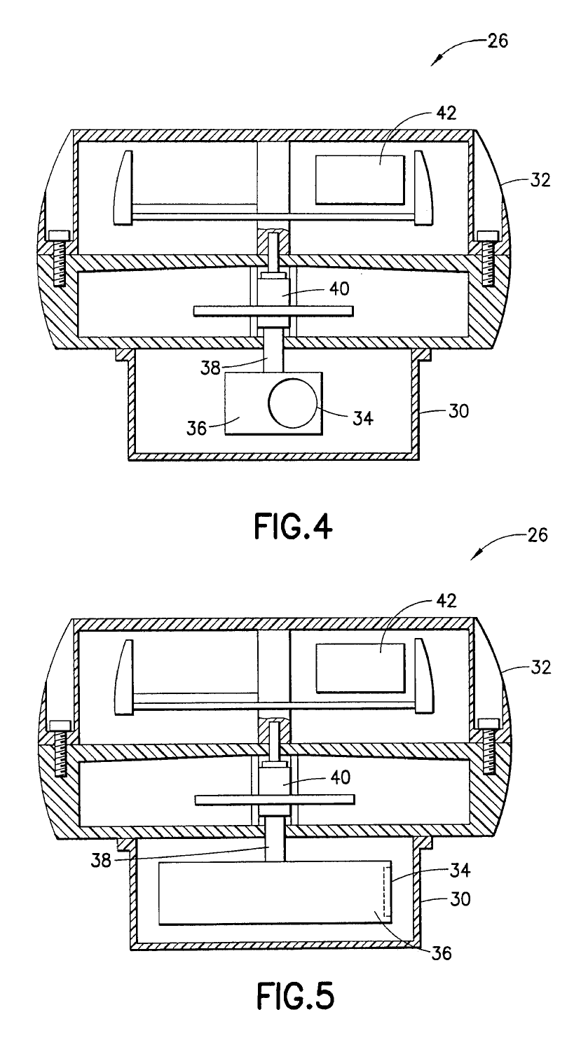

Referring to FIGS. 4 and 5, optical unit casing 26 includes a first lower portion 30 which is preferably formed of a clear watertight acrylic through which light can travel and a second upper portion 32 which is preferably formed of non-metallic watertight polymer. First lower portion 30 includes a light source 34 and light sensitive sensor 36, which, in an embodiment, comprises a single unit.

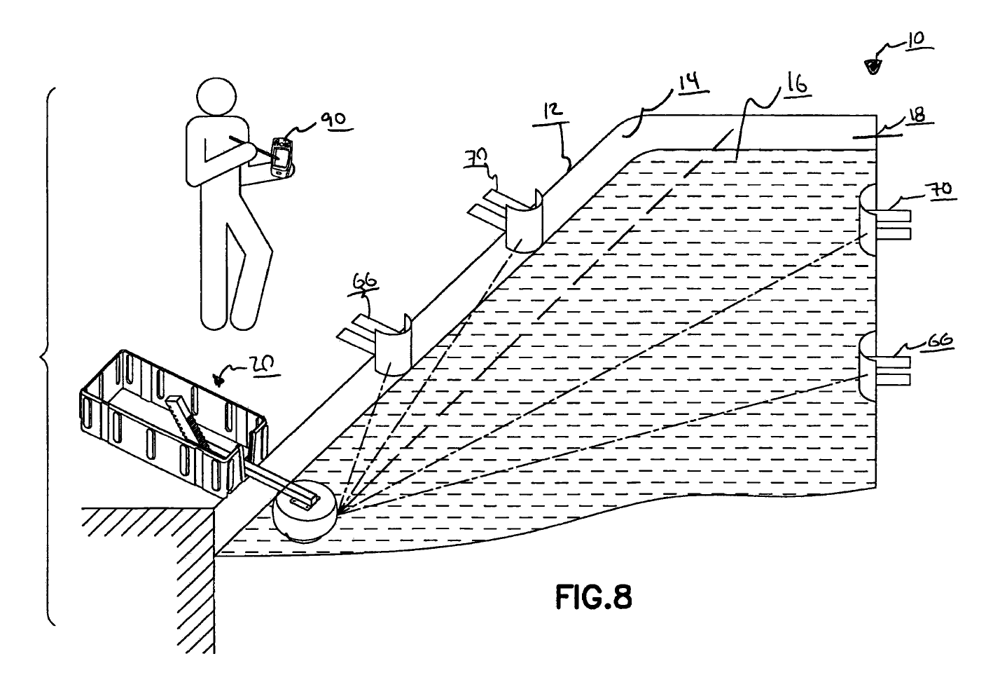

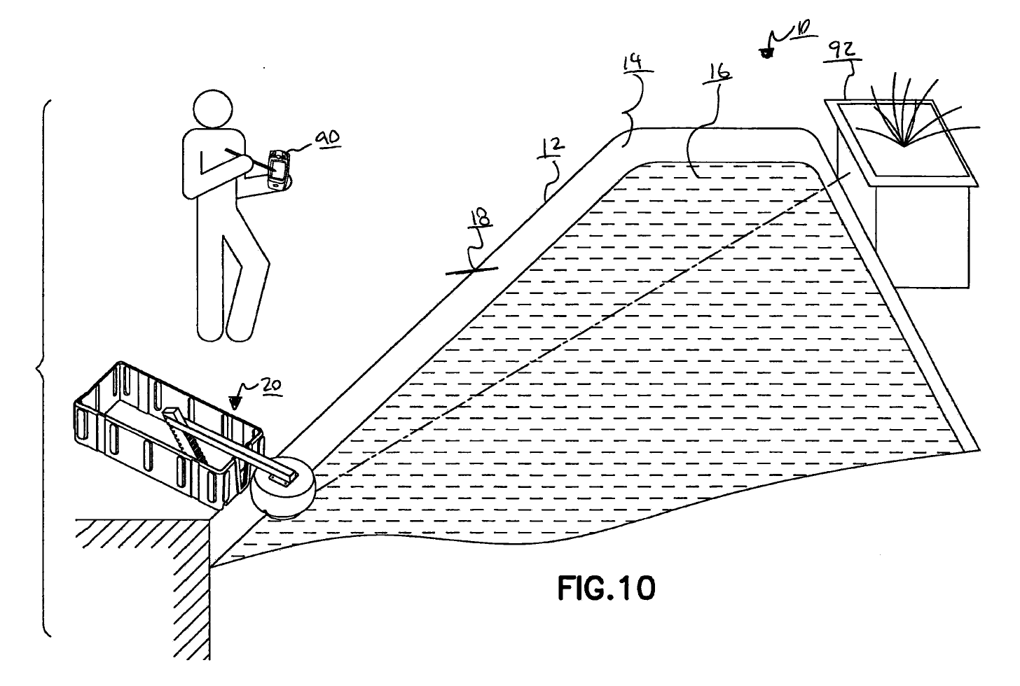

Referring to FIGS. 7 and 8, optical unit casing 26 is preferably positioned above the water surface 16 of a swimming pool 10 and below the plane of the swimming pool deck 18 when portable optical measurement assembly 20 is use. In a first configuration of portable optical assembly 20, light source 34 is structured and arranged to direct a light beam onto the surface of an upper peripheral region of a wall structure 14 of swimming pool 10. Sensor 36 is structured and arranged to provide data indicative of the distance that the light beam travels from light source 34 to the surface of the upper peripheral region of a wall structure. Referring to FIG. 10, in a second configuration of portable optical assembly 20, light source 34 is structured and arranged to direct a light beam at onto structures above the plane of a swimming pool deck 18.

Light source 34 preferably emits a class 2 laser beam which operates on a time of flight principle. A laser pulse is sent in a narrow beam towards a surface. The laser beam is detected by sensor 36 when it reflects off the surface. The time it takes for the laser beam to reach the surface and be detected by sensor 36 is measured. This time is calculated against the known speed of light to determine the distance between the light source 34 and the surface and recorded as a measurement data point. The process is repeated at multiple points along the surface of the upper peripheral wall region of swimming pool 10 to acquire data indicative of the measurements of the perimeter of swimming pool 10. For a simple-shaped swimming pool such as an 16′ by 32′ kidney shaped pool, provide measurement data indicative of about 800 points around the perimeter of the pool. More data points can be acquired at regions of a swimming pool's upper peripheral wall region that have complex shapes.

Referring back to FIGS. 4 and 5, light source 34 and sensor 36 are connected by a shaft portion 38 to a motor 40 located in second upper portion 32 of optical unit casing 26. Motor 40 is structured and arranged to continuously rotate the light source 34 and sensor 36 directing the light beam around substantially the entire upper peripheral region of the surface of a wall structure of a swimming pool. In an embodiment, motor 40 is not utilized and light source 34 can be rotated manually. Preferably, the light beam remains at the same distance relative to plane of the deck of the swimming pool at each point to ensure accurate measurements. Second upper portion 32 also may include a level-detecting device, which determines if light source 34 and sensor 36 are level or have become tilted. The level-detecting device is coupled to a leveling motor, which modifies the positioning of light source 34 and sensor 36 if they have become tilted. Incorrect leveling may lead to collection of incorrect measurement data points. A wireless communication device such as a bluetooth communicator can also positioned in second upper portion 32. The wireless communication device is structured and arranged to send recorded measured data points to a data storage device 90, discussed further below. A battery 42 and a battery charging device may also positioned in second upper portion 32 of optical unit casing 26. Battery 42 provides power to motor 40, light source 34, and sensor 36. The battery charging device recharges battery 42 when the battery charging device is connected to an external power source.

Referring again to FIGS. 1, 2, and 3, mounting assembly 24 includes a housing 48. Housing 48 is preferably a portable molded plastic container with an interior and exterior, a retractable handle and wheels 50 positioned at an end. Housing 48 has four upright walls connected by a base. Components of portable optical measurement assembly 20 including the optical unit subassembly 22 and the data storage device 90 can be placed inside housing 48 for easy transport to and from pool locations. A cover (not shown) is provided to close housing 48 when portable optical measurement assembly 20 is not in use.

Adjustable feet 52 are located at the base of housing 50 and may be adjusted to compensate for uneven ground surfaces by the perimeter of a swimming pool. Elongate support beam 28 has a bubble level 54 which is used to determine if housing 48 is level with the ground surface. Adjustable feet 52 are manipulated until bubble level 54 indicates that housing 48 is level. Housing 48 includes a base portion 56 preferably formed of a metal such as steel although other materials may be employed. Base portion 56 provides a counterweight for mounting assembly 24 in position when optical unit subassembly 22 is deployed and in use.

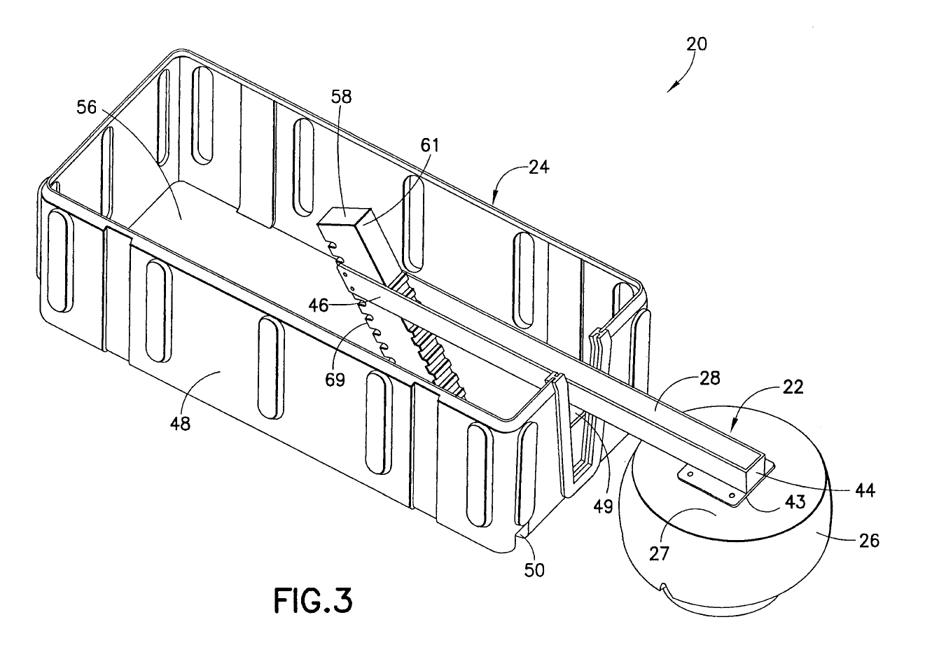

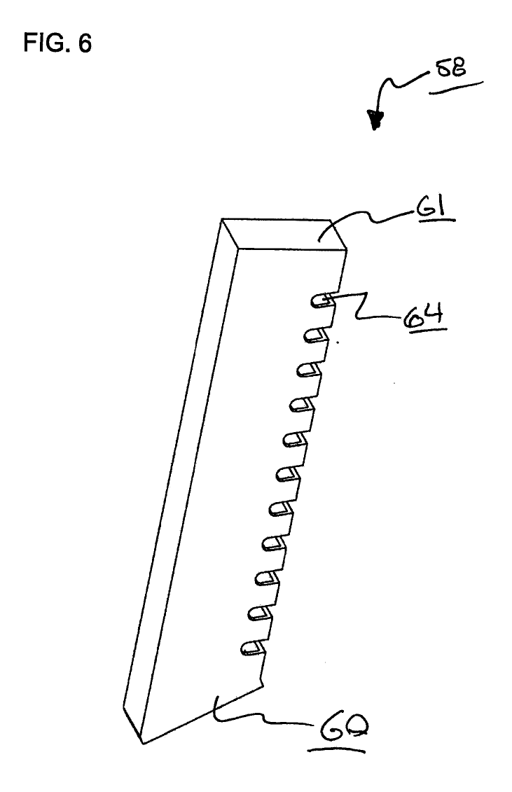

Referring now to FIGS. 2, 3 and 6, mounting assembly 24 also includes an elongate rack 58 having a first end 60 hingedly connected to base portion 56 and a second free end 61. Rack 58 is preferably formed of a metallic material such as steel or aluminum, although other material may be employed. Rack 58 is moveable from a first supine position, wherein rack 58 lies flat against base portion 56 to a second upright position wherein rack 58 extends at an upward angle from base portion 56 towards the rear of housing 48. Rack 58 includes a plurality of slots 64, spaced from each other, formed along the rear surface of rack 58. The slots 64 are for connection to optical unit support subassembly 22, specifically to second end 46 of elongate support beam 28, which is structured and arranged to be received by slots 64. Elongate support beam 28 may be positioned at different positions along rack 58 depending on a variety of factors such as the evenness of the ground surface, the water level and the construction of the pool. Slots 64 nearest first end 60 define a lowermost connection portion for support beam 28. Slots 64 nearest free end 61 define an uppermost connector portion for support beam 58.

Preferably, in a first configuration, as seen in FIGS. 7 and 8, of a portable optical measurement assembly 20, elongate support beam 28 is positioned on rack 58 such that light source 34 and sensor 36 of optical unit casing 26 are positioned above the surface of the water surface 14 and below plane of the deck 18 of the swimming pool. In this configuration, elongate support beam 28 extends through an opening 49 in housing 48. In a second configuration, elongate support beam 28 is positioned on rack 58 such that light source 34 and sensor 36 are positioned above the plane of the deck 18 of the swimming pool 10.

Referring to FIGS. 8 and 10, the portable optical measurement assembly 20 is structured and arranged to communicate measurement data points representative of swimming pool 10 to data storage device 90, such as a handheld personal digital assistant (PDA). For example, the measurement data can include a variety of data corresponding to substantially all points along an inner surface of a wall structure of a swimming pool 10. The data storage device 90 can also be used as a controller to initiate or turn off portable optical measurement assembly 20.

Data storage device 90 includes a receiver for receiving the wireless communications from the portable optical measurement assembly 20. Data storage device 90 can include a liquid crystal display (LCD) screen or other display device, buttons or switches by which the operation of the device can be controlled, a batter or other power source and the like. For example, the LCD screen can be used to display instructions to a user of data storage device 90 for operation of the portable optical measurement assembly 20. The data storage device may also be used to control operational aspects of the portable optical measurement assembly 20 such as the number of data points collected for an entire swimming pool or the number of measurement data points collected in a certain region of a swimming pool. The LCD screen can also display the collected measurement data in a graphical form, showing a three-dimensional or two-dimensional view of swimming pool to ensure that the measurement data collected is accurate. Data storage device 90 may have a digital camera function. The digital camera is used to take pictures of a swimming pool for later comparison with measurement data.

Referring to FIGS. 7 and 8, portable optical measurement assembly 20 is shown positioned at a perimeter edge 12 of a swimming pool 10. Portable optical measurement assembly 20 can be used to measure dimensions of various configurations of swimming pools including L-shaped, lagoon shaped and any other configuration for manufacture of a swimming pool liner or a swimming pool cover. The portable optical measurement assembly 20 can also be used to measure a swimming pool of a constant depth or a swimming pool wherein the depth changes.

In operation, measurement data for manufacture of a swimming pool liner for a swimming pool 10 that has a constant depth throughout, i.e., there is no deep end of the pool, can be acquired using portable optical measurement assembly 20. Portable optical measurement assembly 20 is positioned at the perimeter edge 12 of a swimming pool 10, preferably at a location from which the entire swimming pool 10 can be measured. Elongate support beam 28 is positioned on rack 58 such that optical unit casing 26 is positioned above the water surface 14 and below the plane of the swimming pool deck 18, such that a light beam emitted from light source 34 is directed the surface of a wall structure 16 of the swimming pool 10 above the water surface 14. Light source 34 and sensor 36 are rotated continuously such that the light beam is directed around substantially the entire upper peripheral region of the wall structure 16 of swimming pool 10. A plurality of measurement data points relating to the perimeter of the swimming pool are collected, each measurement data point at substantially the same distance below the top of the plane of the swimming pool deck 18. For a conventional pool shape, portable optical measurement assembly 20 provides measurement data indicative of the distance of about 800 points around the perimeter of the pool. Additional data points may be collected for more complex pool structures. The depth of the pool is manually measured using a measurement device such as a tape measure or laser range finder and the depth is entered into data storage device 90. The measurement data indicative of the perimeter of the pool and the depth measurements are entered into a processor. The processor, using specialized software, constructs a three-dimensional depiction of the pool, which facilitates manufacture of a swimming pool liner.

In operation, measurement data for the manufacture of swimming pool liners for a swimming pool 10 which does not have a constant depth can be acquired using portable optical measurement assembly 20. Such swimming pools are typical in the industry and have a shallow end and a deep end. A first pair of markers 66 are positioned at the perimeter edge of shallow break line 68, which is a location at the bottom surface of a swimming pool, stretching from one end to an opposite end, where the bottom surface of swimming pool 10 begins to transition from a flat surface to a sloping surface. A second pair of markers 70 are positioned at the perimeter edge of deep break line 72, which is a location at the bottom surface of a swimming pool stretching from one end to an opposite end where the bottom surface of the swimming pool transitions from a sloping surface to a flat surface again. Shallow break line 68 may be, for example, at a depth of about 3′1″ and deep break line 72 may be, for example, at a depth of about 8′6″. The area 71 bounded by shallow break line 68 and deep break line 72 descends at a constant slope which can be calculated using the depth measurements at shallow break line 68 and deep break line 72.

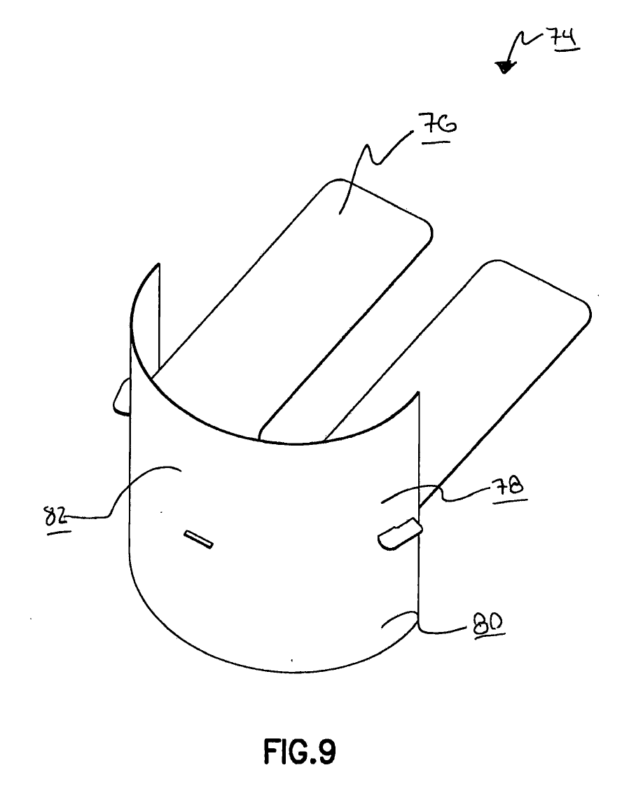

Referring now to FIG. 9, a marker 74 for indicating a change in depth of a swimming pool is shown. Marker 74 has a substantially planar first surface 76 that is for connection to a perimeter edge of a swimming pool. First surface 76 is substantially U-shaped and structured and arranged for connection to second surface 78. Second surface 78 is curved and, when marker 74 is attached to the perimeter edge 12 of a swimming pool, second surface 78 extends towards the interior of the pool. Second surface 78 has a lower portion 80 which descends below the plane of the swimming pool deck and an upper portion 82 which extends above the plane of the swimming pool deck. Lower portion 80 is detected by portable optical measurement assembly 20 during collection of measurement data points. The curved surface of lower portion 80 indicates that a change in pool depth occurs at the location of the marker.

Referring again to FIGS. 7 and 8, portable optical measurement assembly 20 is positioned by the perimeter edge 12 of swimming pool 10. Elongate support beam 28 is positioned such that light source 34 is positioned above the water surface 16 and below the plane of the swimming pool deck 18, wherein a light beam emitted from light source 34 is directed at the surface of a wall structure 16 of the swimming pool 10. Optical unit casing 26 is also positioned such that the light beam is directed to the first pair of markers 66 and second pair of markers 70 upon rotation. Light source 34 and sensor 36 are initially rotated so that the light beam is directed to first pair of markers 66 and second pair of markers 70 at least three times. Measurement data regarding the location of the markers is communicated and stored on data storage device 90. After collection of data regarding the positioning of the markers, light source 34 and sensor 36 are rotated continuously such that the light beam is directed to substantially the entire upper peripheral region of the wall structure 16 of the swimming pool 10. A plurality of measurement data points indicative of the perimeter of the swimming pool are collected, each measurement data point at substantially the same distance below the top of the plane of the swimming pool deck 18. For a conventional pool shape, portable optical assembly 20 provides measurement data indicative of the distance of about 800 points around the perimeter of the pool. Additional data points may be collected for more complex pool structures. The depth of the swimming pool at shallow break line 68 and deep break line 72 are measured and entered into data storage device 90 and processed as described below. The measurement data indicative of the perimeter of the pool and the depth measurements are entered into a processor. The processor, using specialized software, constructs a three-dimensional depiction of the pool, which facilitates manufacture of a swimming pool liner.

If a swimming pool 10 has an irregular shape such that portable optical measurement assembly 20 cannot collect a complete set of measurement data for manufacture of a pool liner at a single location, portable optical measurement assembly 20 is repositioned to a second location along the perimeter 12 of swimming pool 10 after collection of a first set of measurement data points. At the second location, portable optical measurement system 20 acquires a second set of measurement data points, including measurement data indicative of the positioning of the first pair of markers 66 and second pair of markers 70. The data sets are combined, stored together and processed for manufacture of a swimming pool liner.

Referring now to FIG. 10, in operation, measurement data for manufacture of a pool cover can be measured using portable optical measurement assembly 20. Portable optical measurement assembly 20 is positioned at the perimeter edge 12 a swimming pool 10 as described above. A first set of measurement data points is acquired as described above for the manufacture of a pool liner. A second set of measurement data points is subsequently collected relating to structures 92 surrounding the perimeter of swimming pool 10. Elongate support member 28 is repositioned to a second configuration on rack 58 such that optical unit casing 26 is above the plane of the swimming pool deck 18. A light beam emitted by light source 36 is no longer directed at the wall structure 16 of swimming pool 10, but instead to structures above the plane of the swimming pool deck. Light source 34 and sensor 36 are continuously rotated such that the light beam of light source 36 is directed at any structures 92 in proximity to the perimeter edge 12 of the swimming pool. Such structures may include a pool ladder, a diving board, a fountain or any other structures which may interfere with the placement of a pool cover. The second set of measurement data points is stored on data storage device 90. The measurement data indicative of the perimeter of the pool and the measurement data points indicative of the structures surrounding the pool are entered into a processor. The processor, using specialized software, constructs a depiction of the pool and its surroundings, which facilitates manufacture of a swimming pool cover.

Upon completion of data collection, the measurement data can be reviewed on data storage device 90. Data storage device can wirelessly communicate the measurement data to a main processor or alternatively, can process the data for manufacture of a swimming pool liner and/or a swimming pool cover.

The measurement data points are uploaded to a processing device such as a programmable computer. The processing device receives measurement data from data storage device 90. The measurement data is processed by software for processing such data, such as iPool, a proprietary software of Latham Plastics of Latham, N.Y. The software processes collected measurement data points and reconstructs the measurement data points through, for example, a CAD program such as AutoCAD®. The measurement data points are used to construct a three-dimensional model of the swimming pool, that includes the inner surfaces of the pool. The processing device can determine changes in depth of the pool using the measurement data and the marker location data along with the measured depth of the pool at the shallow break point and the deep break point. Using these measurements, specific measurements for cutting a pool liner or pool cover to fit a pool can be ascertained.

Unless defined otherwise, all technical and scientific terms used herein have the same meaning as commonly understood by one of ordinary skill in the art to which this invention pertains. Although any methods and materials similar or equivalent to those described herein can also be used in the practice or testing of the present invention, the preferred methods and materials are now described.

The invention has been described with reference to an embodiment that illustrates the principles of the invention but which is not meant to limit the scope of the invention. Modifications and alterations may occur to others upon reading and understanding the preceding detailed description. It is intended that the scope of the invention be construed as including all modifications and alterations that may occur to others upon reading and understanding the preceding detailed description insofar as they come within the scope of the following claims or equivalents thereof. Various changes may be made without departing from the spirit and scope of the invention.

We claim:

1. A portable optical measurement assembly for measuring the dimensions of an upper peripheral region of a wall structure of a swimming pool comprising:
an optical unit subassembly comprising an optical unit casing, the optical unit casing enclosing a light source structured and arranged to direct a light beam onto an upper peripheral region of a wall structure of a swimming pool surface and said light source and a sensor structured and arranged to provide data indicative of the distance from said light source to a point on said upper peripheral region of a wall structure of a swimming pool surface; and
a mounting assembly for rotatably supporting the optical unit subassembly.

2. The portable optical measurement assembly of claim 1, further comprising a motor for continuously rotating said light source and directing the light beam around substantially the entire upper peripheral region of the wall structure of the swimming pool.

3. The portable optical measurement assembly according to claim 1, wherein said mounting assembly comprises a housing positioned adjacent to a perimeter edge of a swimming pool and an elongate rack having a first end hingedly attached to a base of said housing, and wherein said elongate rack is structured and arranged for connection to the optical unit subassembly.

4. The portable optical measurement assembly according to claim 3, wherein said housing is structured and arranged to contain said optical unit assembly and said elongate rack.

5. The portable optical measurement assembly according to claim 3, wherein the optical unit subassembly further comprises a support beam having a first end connected to said optical unit casing and a second end structured and arranged for connection to said elongate rack.

6. The portable optical measurement assembly according to claim 5, wherein said elongate rack has a plurality of slots spaced from each other, the slots structured and arranged for connection to the second end of said support beam, the slots defining an uppermost connection portion and a lowermost connection portion.

7. The portable optical measurement assembly according to claim 1, wherein said optical unit casing further comprises:
a level-detecting device structured and arranged to detect an imbalance of said light source and sensor; and
a leveling motor coupled to said level-detecting device, the leveling motor structured and arranged to modify the position of the light source and sensor when said level-detecting device detects an imbalance.

8. The portable optical measurement assembly according to claim 1, wherein said optical unit casing further comprises a battery for providing power to said light source and sensor.

9. The portable optical measurement assembly according to claim 1, wherein said optical unit casing further comprises a wireless transmission device structured and arranged to wirelessly transmit measurement data to a data storage device.

10. The portable optical measurement assembly according to claim 1, wherein said sensor is structured and arranged to determine distance data corresponding to about 800 points along the upper peripheral region of a wall structure of a swimming pool.

11. The portable optical measurement assembly according to claim 1, wherein the light beam is a laser beam.

12. A method of measuring the dimensions of a swimming pool comprising the steps of:
providing a portable optical measurement assembly comprising an optical unit casing including a light source structured and arranged to emit a light beam onto an upper peripheral region of a wall structure of a swimming pool surface;
positioning the portable optical measurement assembly at a perimeter edge of a swimming pool such that said optical unit casing is at a position below the plane of a swimming pool deck and above a water surface of a swimming pool;
rotating said optical unit casing and directing the light beam onto points situated around substantially the entire upper peripheral region of the wall structure of swimming pool surface;
measuring the distance from said light source to said points situated around the upper peripheral region of the wall structure of the swimming pool surface; and
storing measurement data relating to the dimensions of the swimming pool.

13. The method according to claim 12, further comprising the steps of:
repositioning said optical unit casing to a second position above the plane of the swimming pool deck;
rotating said optical unit casing and directing the light beam around substantially the area surrounding the perimeter above the swimming pool to determine the position of structures in proximity to the perimeter of said swimming pool;
measuring the distance from said light source to said structures in proximity to the perimeter of said swimming pool; and
collecting and storing measurement data relating to the structures in proximity to the perimeter of said swimming pool.

14. The method according to claim 13, further comprising the step of cutting a pool cover material according to said measurement data relating to the dimensions of the pool and said measurement data relating to structures in proximity to the perimeter of said swimming pool such that the pool cover material conforms to the measurements of the pool.

15. The method according to claim 12, further comprising the steps of:
positioning a first pair of markers at an upper peripheral region of a wall structure of a swimming pool located at the ends of a shallow break line of a swimming pool and measuring the depth at said shallow break line;
positioning a second pair of markers on an upper peripheral region of a wall structure of a swimming pool located at the ends of a deep break line and measuring the depth at said deep break line;
rotating said optical unit casing and directing said light beam around the upper peripheral region of the wall structure of the swimming pool;
measuring the distance from said light source to each of said first pair of markers and each of said second pair of markers to determine the position of the shallow and deep break lines; and
storing measurement data relating to the depth of the shallow and deep break lines.

16. The method according to claim 15, further comprising the step of cutting a liner material according to the measurement data relating to the dimensions of the pool and measurement data relating to the depth of the shallow and deep break lines, such that the liner material conforms to the pool.

17. The method according to claim 12, further comprising the step of wirelessly communicating the measurement data from the portable optical measurement assembly to a memory device.

18. A portable optical measurement system for measuring the dimensions of a pool comprising:
a portable optical measurement assembly comprising:
an optical unit subassembly comprising an optical unit casing, the optical unit casing enclosing a light source structured and arranged to emit a light beam onto an upper peripheral region of a wall structure of a swimming pool surface and said light source and a sensor structured and arranged to provide data indicative of the distance from said light source to a point on said upper peripheral region of a wall structure of a swimming pool surface; and
a mounting assembly for rotatably supporting the optical unit subassembly; and
at least two pairs of markers for indicating a change in depth of a swimming pool; and
a data storage device structured and arranged to receive and store measurement data from said portable optical measurement assembly.

19. The system according to claim 18, wherein each of the at least two pairs of markers have a first portion structured and arranged for attaching said markers to an upper peripheral edge of a swimming pool and a second portion structured and arranged to communicate the position of a swimming pool break line to said sensor.

20. The system according to claim 18, wherein said portable optical measuring assembly is structured and arranged to wirelessly transmit said measurement data to said data storage device.

21. A device for emitting a light beam onto a series of points on a surface for generating data indicative of the distance between the device and each of said series of points on said surface; and
a processor for processing said data to generate a graph of the contour of said surface.
